(19) United States
(12) Patent Application Publication
(10) Pub. No.: US 2026/0257122 A1
(43) Pub. Date: Sep. 3, 2026

(54) WEARABLE SYNCHRONIZATION FEEDBACK SYSTEMS FOR MOVEMENT TRAINING, PERFORMANCE ANALYSIS, AND COORDINATED MOTION GUIDANCE

(71) Applicant: James Brown, Fountain Valley, CA (US)

(72) Inventor: James Brown, Fountain Valley, CA (US)

(21) Appl. No.: 19/684,009

(22) Filed: May 21, 2026

(51) Int. Cl. A63B 71/06; A63B 24/00; G06F 3/01

(52) U.S. Cl. CPC A63B 71/0622; A63B 24/0006; A63B 24/0062; G06F 3/016; A63B 2024/0015; A63B 2071/0655; A63B 2220/40; A63B 2220/836; A63B 2225/20; A63B 2225/54

(57) ABSTRACT

Provided herein are wearable synchronization and movement feedback systems configured to monitor, analyze, and improve coordinated movement. The system includes one or more wearable devices comprising motion sensors, spatial awareness systems, wireless communication modules, and feedback systems configured to detect movement deviations and provide corrective guidance in real time. The wearable devices may communicate with software platforms configured to analyze timing, positioning, orientation, spacing, and synchronization relative to one or more reference movements or other users. Corrective feedback may include haptic, auditory, or visual cues. The system may further include RFID-based positioning systems, machine learning analysis, remote coaching functionality, synchronization scoring, and group performance analytics. The disclosed systems and methods may be applied to dance, sports, rehabilitation, military drills, physical therapy, industrial training, and other coordinated movement environments.

### FIELD OF THE INVENTION

The field of the invention relates generally to wearable motion analysis systems, and more particularly to wearable systems, devices, software architectures, and feedback platforms configured to monitor, analyze, predict, guide, and improve synchronized movement, coordinated physical activity, and motion precision across one or more users.

### BACKGROUND

The following description includes information that may be useful in understanding the present invention. It is not an admission that any of the information provided herein is prior art or relevant to the presently claimed invention, or that any publication specifically or implicitly referenced is prior art.

All publications and patent applications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Many human activities require precise movement, coordinated motion, synchronized timing, spatial alignment, or repeatable biomechanical performance. Such activities may include dance, cheerleading, gymnastics, synchronized swimming, martial arts, marching band activities, military drills, physical rehabilitation, sports training, occupational therapy, and group exercise.

Traditionally, coaches, choreographers, trainers, instructors, or therapists evaluate movement quality through visual observation. Such observation-based systems suffer from numerous drawbacks. Human observation is inherently subjective, difficult to scale across large groups, and often unable to detect subtle timing errors, angular deviations, or spatial inconsistencies.

Existing motion tracking systems frequently depend on fixed cameras, external markers, optical tracking systems, infrared systems, or specialized studio environments. While such systems can provide useful information, they are often expensive, immobile, computationally intensive, and unsuitable for routine daily use.

Camera-based systems may also suffer from occlusion issues, environmental lighting limitations, calibration complexity, restricted operating areas, and privacy concerns. Moreover, many existing systems are not suitable for outdoor environments, athletic fields, or distributed group settings.

Wearable activity trackers are also known in the art. However, most existing wearable devices are directed toward generalized fitness tracking such as counting steps, measuring heart rate, or estimating caloric expenditure. Such systems generally do not provide real-time synchronization analysis, coordinated group monitoring, or directional corrective feedback for precise movement execution. Likewise, existing wearable devices generally fail to provide meaningful feedback regarding whether a user is moving in synchrony with another user, whether a formation is correctly aligned, whether a movement sequence is correctly timed, or whether a body segment deviates from an expected trajectory.

In many coordinated activities, timing differences of even fractions of a second can significantly affect performance quality. Similarly, improper spacing, incorrect directional movement, or inconsistent body positioning can negatively affect both aesthetic and functional performance. Coaches and instructors are often unable to continuously monitor all participants simultaneously, especially in large groups. Accordingly, participants frequently continue practicing incorrect movements without immediate correction.

Thus, there remains a need in the art for wearable systems capable of monitoring movement in real time while simultaneously providing immediate corrective guidance to one or more users. There further remains a need for portable systems that do not require fixed infrastructure, specialized environments, or optical camera systems.

There also remains a need for systems capable of objectively evaluating synchronization, spatial positioning, movement accuracy, formation integrity, timing precision, and technique quality across both individuals and groups.

There further remains a need for systems capable of generating actionable corrective feedback that can be immediately interpreted by a user without requiring interruption of the activity.

The present disclosure addresses these and other deficiencies in the art.

### SUMMARY OF THE INVENTION

The inventive subject matter is directed to wearable synchronization and movement feedback systems configured to monitor, analyze, guide, and improve coordinated movement.

In one aspect, disclosed herein is a wearable device configured to be worn on a user’s wrist, ankle, arm, leg, torso, waist, shoulder, head, foot, or other body region. The wearable device may include one or more motion sensors configured to detect acceleration, angular velocity, orientation, displacement, rotational movement, body position, movement direction, velocity, cadence, impact events, posture, or combinations thereof.

In some embodiments, the wearable device comprises one or more accelerometers, gyroscopes, magnetometers, inertial measurement units (IMUs), spatiometric sensors, optical sensors, depth sensors, pressure sensors, flex sensors, RFID readers, ultra-wideband transceivers, Bluetooth modules, Wi-Fi modules, GPS systems, biometric sensors, or combinations thereof.

In one preferred aspect, the wearable device comprises a haptic feedback system configured to provide corrective cues to the user. In some embodiments, the corrective cues comprise directional vibration patterns, variable intensity vibrations, pulsed vibrations, rhythmic signals, temperature changes, pressure-based feedback, auditory cues, visual cues, light-based indicators, or combinations thereof. In some embodiments, the haptic feedback system communicates movement errors to the user without interrupting the activity being performed.

In another aspect, the wearable device includes a software platform configured to receive movement data from one or more wearable devices. The software platform may compare the movement data against predefined choreography, movement templates, drills, exercises, movement models, synchronization targets, or biomechanical standards.

In some embodiments, the wearable device including the software platform determines whether a user deviates from an expected movement pattern. The deviation may comprise a timing deviation, directional deviation, orientation deviation, spacing deviation, rotational deviation, amplitude deviation, posture deviation, cadence deviation, acceleration deviation, or synchronization deviation.

In another aspect, the wearable device further comprises group synchronization functionality. In this scenario, multiple wearable devices may communicate simultaneously with a central software platform configured to analyze synchronization between participants. The software platform may determine whether one or more users are moving too quickly, too slowly, too early, too late, too far apart, too close together, or otherwise outside predefined synchronization thresholds.

In another aspect, the wearable synchronization and movement feedback system further comprises spatial awareness functionality. In this case, RFID systems, ultra-wideband systems, Bluetooth ranging systems, proximity sensors, environmental markers, or location systems are used to determine spacing between users, proximity to boundaries, formation integrity, prop positioning, or movement within designated zones.

In another aspect, the wearable synchronization and movement feedback system includes machine learning and predictive movement analysis. Here, the system learns user-specific movement tendencies, predicts future movement trajectories, identifies recurrent errors, and generates personalized training recommendations.

In another aspect, the present disclosure comprises methods for improving synchronized movement by monitoring motion data and providing real-time corrective feedback.

In another aspect, the present disclosure provides methods for evaluating group performance based on synchronization scoring, alignment scoring, timing scoring, movement consistency scoring, or combinations thereof.

In another aspect, the wearable synchronization and movement feedback system disclosed herein may provide remote coaching and remote instruction. For example, a coach located remotely from the participants may monitor movement quality in real time and provide corrective guidance through the wearable system.

Thus, the present disclosure advantageously provides objective movement analysis, immediate corrective feedback, scalable monitoring across multiple users, portable operation, reduced reliance on visual observation, enhanced synchronization, improved training efficiency, and improved movement precision.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

Exemplary embodiments are illustrated in referenced figures. It is intended that the embodiments and figures disclosed herein are to be considered illustrative rather than restrictive.

FIG. 1 depicts an exemplary exterior perspective view of a wearable synchronization feedback device configured to be worn on a user’s wrist.

FIG. 2 depicts an exemplary internal component layout of the wearable synchronization feedback device, including motion sensing, wireless communication, haptic feedback, power management, and processing components.

FIG. 3 depicts an exemplary system architecture and communication diagram illustrating communication between multiple wearable devices, a coach or instructor application, a cloud server, a remote monitoring application, and environmental markers.

FIG. 4 depicts an exemplary coach or instructor application interface configured to display synchronization analytics, participant positioning, movement deviations, performance metrics, and corrective feedback information.

FIG. 5 depicts exemplary haptic feedback patterns and corrective cue configurations corresponding to directional movement adjustments, timing corrections, spacing corrections, and synchronization guidance.

FIG. 6 depicts an exemplary RFID-based spatial awareness and positioning system illustrating environmental markers, wearable devices, formation alignment monitoring, spacing analysis, and spatial coordination functionality.

### DETAILED DESCRIPTION

The described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention can be practiced without one or more of the specific details, or with other methods, components and so forth. In other instances, well-known structures, materials, or operations are not shown or described in detail to avoid obscuring aspects of the invention.

The inventors have discovered that coordinated movement training can be substantially improved through wearable systems capable of continuously monitoring movement while simultaneously providing real-time corrective guidance. The system generally includes one or more wearable devices configured to be worn directly on a user’s body during training, performance, rehabilitation, or athletic activity. These wearable devices may be worn on the wrists, ankles, torso, shoulders, knees, feet, head, or other body regions to allow partial-body or full-body movement analysis. The devices may be configured as wristbands, ankle bands, sleeves, straps, clips, patches, garment-integrated systems, footwear-integrated systems, gloves, belts, or head-mounted systems. Multiple wearable devices may be used simultaneously to improve tracking accuracy and provide more comprehensive synchronization analysis.

The wearable devices include one or more motion sensing systems configured to detect movement, orientation, acceleration, rotational motion, posture, and biomechanical activity. Suitable motion sensing systems may include accelerometers, gyroscopes, inertial measurement units (IMUs), magnetometers, GPS systems, optical tracking systems, barometric sensors, lidar systems, ultrasound positioning systems, and other movement-detection technologies. Accelerometers may measure linear acceleration along one or more axes, while gyroscopes may measure angular velocity and rotational movement. The sensors may detect movement speed, movement trajectory, cadence, jump height, impact force, posture, body angle, movement timing, and movement sequencing. In certain implementations, the wearable device continuously monitors user movement during performance or training and transmits the collected data to a software platform for analysis.

The wearable devices of the present disclosure may further include spatial awareness systems configured to determine positioning, spacing, proximity, and formation alignment between users or environmental objects. In some examples, the spatial awareness system includes an RFID reader configured to detect RFID tags positioned throughout a training environment. The RFID tags may define formation positions, boundaries, designated zones, obstacles, or environmental markers. The system may determine whether a user is properly aligned within a formation, whether the user has deviated from an assigned position, or whether users are positioned too close together or too far apart. Ultra-wideband positioning systems and other proximity sensing technologies may also be used to provide highly accurate relative positioning between participants. The system may generate corrective feedback responsive to detected spacing or positioning deviations.

The wearable devices disclosed herein may additionally include haptic feedback systems configured to communicate information to the user through tactile stimulation. The haptic feedback system may include one or more vibration motors positioned at different locations around the wearable device. For example, vibration motors may be positioned on the left, right, upper, and lower portions of the device to provide directional corrective cues. Activation of a left-side motor may indicate that the user should move left, while activation of a right-side motor may indicate movement toward the right. Similarly, upper and lower vibration motors may indicate upward or downward repositioning. The intensity, frequency, and duration of the vibration patterns may correspond to the magnitude, urgency, or type of detected movement deviation. Rapid pulses may indicate that the user should speed up, while slower pulses may indicate that the user should slow down or adjust cadence.

In addition to haptic feedback, the system may provide auditory and visual corrective cues. Auditory feedback may include tones, spoken commands, metronome pulses, synchronization signals, alarms, or music-based timing cues. Visual feedback may include LEDs, graphical displays, projected indicators, wearable light arrays, or color-changing elements integrated into the device. The wearable devices communicate wirelessly with external computing systems such as smartphones, tablets, laptops, desktop computers, smartwatches, cloud servers, coaching consoles, or remote monitoring systems. Wireless communication may occur through Bluetooth, Wi-Fi, NFC, ultra-wideband communication, mesh networking, cellular communication, satellite communication, or proprietary communication protocols. The wearable devices may continuously transmit movement data to a software platform for analysis and feedback generation.

The software platform analyzes movement patterns and compares the movement data against one or more predefined reference movements. A reference movement may include choreography, athletic drills, rehabilitation exercises, movement templates, biomechanical targets, or prerecorded demonstrations from expert performers. The reference movements may be manually programmed, generated from demonstration recordings, derived from expert user data, or dynamically updated using machine learning algorithms. The software platform may determine whether a user deviates from the expected movement pattern by analyzing timing, spacing, orientation, cadence, amplitude, posture, or trajectory. Timing deviations may include early or delayed movements, inconsistent rhythm, or synchronization mismatches. Spatial deviations may include improper spacing, incorrect formation alignment, or trajectory errors. Orientation deviations may include incorrect body angles, posture errors, or improper rotational movement.

Corrective feedback may be generated substantially immediately after the system detects a deviation. In some implementations, the feedback is delivered within less than one second, and more preferably within less than approximately 200 milliseconds. The rapid response time allows users to make real-time corrections without interrupting the activity being performed. The system may continuously operate during dance rehearsals, sports drills, martial arts training, gymnastics practice, synchronized swimming, military exercises, rehabilitation sessions, industrial safety training, or physical therapy exercises. Waterproof and water-resistant embodiments are also contemplated for aquatic applications and outdoor environments. The system may monitor range of motion, track recovery progression, and allow therapists or instructors to remotely evaluate user compliance and performance quality.

The system may further incorporate AI-based movement analysis to improve synchronization and training performance over time. The AI systems may use machine learning models, neural networks, statistical modeling systems, or adaptive computational techniques to evaluate movement patterns and user behavior. The software may learn user-specific movement tendencies, identify recurring synchronization problems, and predict future movement deviations before they occur. The AI systems may adapt corrective feedback according to user skill level, training objectives, fatigue state, or historical performance trends. In some cases, the system may identify injury risks based on movement asymmetry, abnormal biomechanics, repetitive strain patterns, or fatigue-related degradation in performance. The system may also determine whether particular corrective strategies are effective for a specific user or training group.

The software platform may generate synchronization scores representing movement consistency and timing alignment between one or more users and one or more reference movements. These synchronization scores may be displayed graphically, numerically, or in real time through a coaching interface. Coaches and instructors may compare synchronization performance across multiple users and identify users who consistently deviate from synchronization targets. The system may also identify movement leaders and movement followers within a group to determine whether performers remain synchronized with a designated lead participant. Historical synchronization data may be stored and analyzed over time to identify long-term improvement trends or recurring deficiencies. The software platform may additionally generate movement heat maps, spatial trajectory maps, and formation drift analytics to assist coaches in evaluating performance quality.

The presently disclosed device also supports remote coaching and distributed training environments. Movement data collected from the wearable devices may be transmitted to a remote coach or instructor who can monitor participants in real time. The remote coach may provide live corrective feedback, modify choreography templates, adjust synchronization thresholds, or review recorded performance sessions. In some implementations, the system includes gamification features such as achievement scores, synchronization rankings, badges, progression indicators, and competitive scoring systems. Group synchronization competitions may be conducted using objective movement metrics generated by the software platform. The system may further support cloud-based analytics, allowing users and coaches to compare performance data across multiple training sessions or large groups of participants.

The wearable devices may additionally include biometric sensing systems configured to collect physiological data from the user. Suitable biometric sensing systems may include heart rate sensors, respiration sensors, temperature sensors, sweat sensors, muscle activity sensors, blood oxygen sensors, and fatigue detection systems. The software platform may correlate biometric information with movement performance to determine whether fatigue, stress, or physiological strain is affecting synchronization quality or movement precision. The system may automatically adjust feedback intensity or training recommendations according to the user’s physiological state. Some embodiments may include onboard processing systems that perform movement analysis locally on the wearable device, while other embodiments may rely on cloud-based computing systems or hybrid processing architectures. The devices may also include rechargeable batteries, wireless charging systems, low-power operating modes, and battery management systems to support prolonged use during training or performance activities.

The present disclosure further supports mesh communication among multiple wearable devices, allowing direct inter-device synchronization and timing exchange. In such implementations, wearable devices may communicate directly with each other to maintain synchronization within a group. The system may identify synchronization leaders within the group and automatically adapt timing references according to a designated lead performer. Environmental awareness functionality may also be included to detect obstacles, terrain conditions, lighting conditions, weather, or restricted zones. The system may generate warnings when a user approaches unsafe areas or exits predefined boundaries. Wearable devices may be integrated into footwear, gloves, compression garments, or other athletic equipment to provide specialized motion analysis for different activities. Footwear-integrated embodiments may measure gait, stride length, jump landing consistency, and running cadence, while glove-integrated embodiments may measure hand positioning, strike timing, or grip motion.

Further disclosed herein are methods for improving synchronized movement using the wearable systems described herein. Such methods may include positioning wearable devices on one or more users, collecting movement data from the devices, comparing the movement data against predefined reference movements, identifying movement deviations, and generating corrective feedback responsive to the detected deviations. The corrective feedback may be delivered through haptic systems, auditory systems, visual systems, or combinations thereof. Over time, the system may learn optimal correction strategies for individual users and generate predictive corrections before synchronization failures occur. Preferably, the present methods illustrate monitoring groups of users by simultaneously receiving motion data from multiple wearable devices and generating group synchronization metrics, formation quality metrics, and alignment analytics.

The wearable synchronization system may be applied across a wide range of fields and industries. Example applications include dance, cheerleading, gymnastics, martial arts, football, soccer, basketball, volleyball, hockey, military drills, physical therapy, rehabilitation, industrial safety training, and synchronized swimming. In rehabilitation environments, the system may assist with gait retraining, balance correction, post-stroke therapy, neurological rehabilitation, orthopedic rehabilitation, and injury recovery. The presently described device, system, and methods may also be used within virtual reality or augmented reality systems where synchronized movements are represented through virtual avatars or collaborative digital environments. In competitive environments, the system may automatically evaluate synchronization quality and provide objective scoring metrics for judges, coaches, or evaluators. The disclosed systems are further capable of identifying movement smoothness, directional consistency, motion symmetry, and coordination between upper-body and lower-body movement.

The system may further support adaptive synchronization thresholds and individualized feedback profiles. Synchronization thresholds may change dynamically according to user skill level, environmental conditions, fatigue state, training progression, or contextual performance requirements. Different users within a group may receive different corrective feedback depending on their role, position, or skill level. Experienced users may serve as synchronization anchors for inexperienced users during collaborative training sessions. The system may continuously recalibrate movement references, compensate for sensor drift, and support offline operation when network connectivity is unavailable. In offline modes, movement data may be stored locally and synchronized later when connectivity is restored.

The disclosed systems additionally support multilingual coaching interfaces, automated coaching summaries, and recommendation systems configured to identify corrective drills for specific movement deficiencies. APIs may allow integration with third-party training systems, music playback systems, choreography tools, or competition management platforms. Synchronization analysis may occur relative to musical timing using beat detection algorithms and tempo analysis. The system may dynamically adjust cadence cues according to changes in music tempo or choreography timing. Instructors may upload custom choreography or movement templates, and AI systems may automatically generate movement libraries from recorded demonstrations. The disclosed systems may be used for esports-style synchronization competitions in which teams or performers are ranked according to objective synchronization metrics generated in real time.

The present system advantageously provides a portable and scalable movement synchronization platform capable of operating without fixed cameras or specialized installations. The system enables objective movement evaluation, immediate corrective guidance, and real-time synchronization analysis across individuals or large groups. By reducing reliance on subjective human observation, the system and devices disclosed herein improves coaching efficiency, training accuracy, synchronization quality, and movement precision. The system may also improve learning speed by providing users with immediate, actionable corrective feedback during performance or practice. Numerous modifications, configurations, and alternative implementations are contemplated without departing from the scope of the invention.

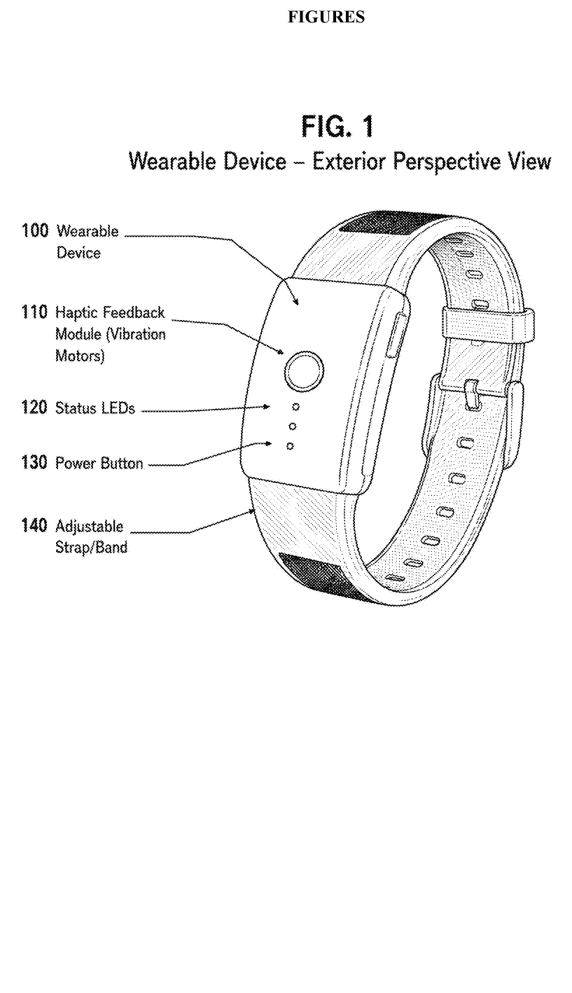

FIG. 1 depicts an exemplary exterior perspective view of a wearable device 100. The wearable device 100 is shown in the form of a wrist-worn band, although the same device may also be configured to be worn on an ankle, arm, leg, torso, waist, shoe, glove, garment, or other body location. The wearable device 100 includes a housing that supports electronic components used to collect movement data and provide feedback to a user during training or performance. The illustrated wristband configuration is merely exemplary and is not intended to limit the wearable device to any particular shape, size, or location on the body.

In FIG. 1, the wearable device 100 includes a haptic feedback module 110. The haptic feedback module 110 may include one or more vibration motors, tactile actuators, pressure actuators, piezoelectric elements, or other tactile output components. The haptic feedback module 110 provides physical feedback to the user in response to detected movement deviations, timing errors, spacing errors, posture errors, or synchronization errors. For example, the haptic feedback module 110 may vibrate to tell the user to move left, move right, speed up, slow down, increase movement amplitude, decrease movement amplitude, or return to a target position.

The wearable device 100 further includes one or more status LEDs 120. The status LEDs 120 may indicate device status, power status, wireless connection status, battery level, training mode, synchronization status, or whether the user is on target or deviating from a reference movement. The LEDs may use different colors, blinking patterns, or illumination sequences to communicate different operational states. For example, a green LED may indicate that the device is connected and operating properly, while a red or blinking LED may indicate low battery, loss of connection, or a movement deviation.

The wearable device 100 also includes a power button 130. The power button 130 may be used to turn the device on or off, place the device into a pairing mode, start or stop a training session, or reset the device. In some implementations, the power button 130 may be a physical button, capacitive touch button, recessed switch, or multifunction input. Although only one power button is shown, the device may include additional user controls, such as volume controls, feedback intensity controls, mode selection buttons, or touch-sensitive input regions.

FIG. 1 also shows an adjustable strap or band 140. The adjustable strap or band 140 allows the wearable device 100 to be secured to the user’s body during movement. The strap or band 140 may include holes, buckles, hook-and-loop fasteners, elastic materials, magnetic connectors, snap-fit closures, or other attachment mechanisms. The strap may be formed from silicone, rubber, fabric, polymer, leather, textile, or other flexible material. The adjustable nature of the strap allows the device to fit different users and different body locations while maintaining sufficient contact for accurate sensing and effective haptic feedback.

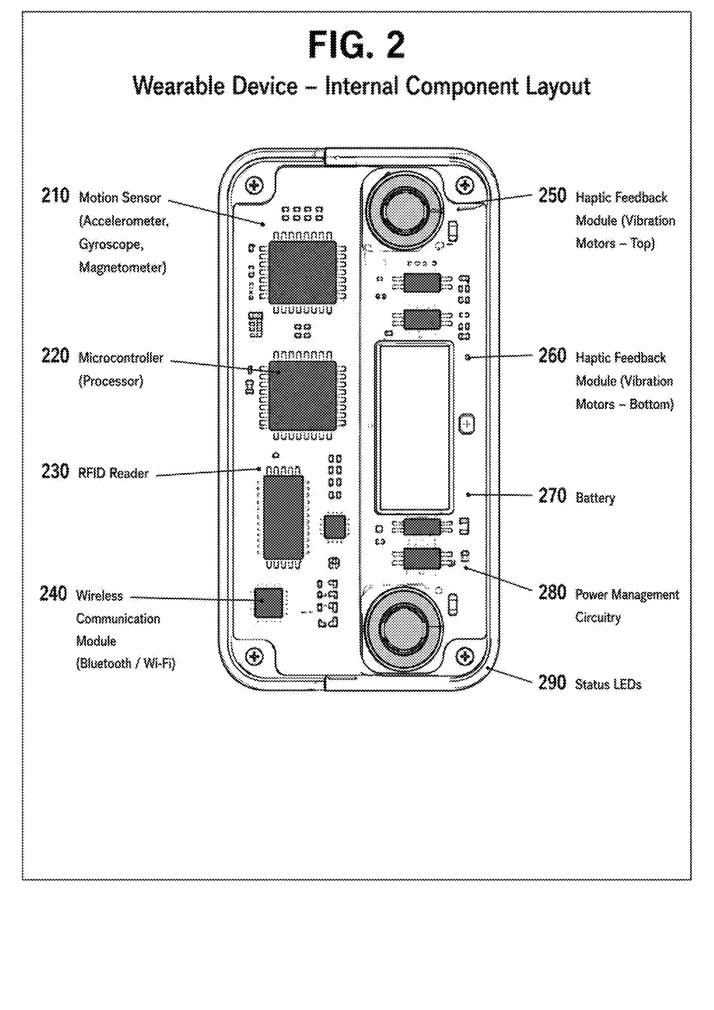

FIG. 2 depicts an exemplary internal component layout of the wearable device. The internal components may be positioned within the housing of the wearable device 100 shown in FIG. 1. FIG. 2 illustrates how the wearable device may include multiple electronic systems that cooperate to sense motion, determine location or proximity, communicate with external devices, process data, store power, and deliver feedback. The illustrated arrangement is exemplary, and the components may be rearranged, combined, miniaturized, separated, or distributed across multiple circuit boards without departing from the scope of the invention.

In FIG. 2, the wearable device includes a motion sensor 210. The motion sensor 210 may include an accelerometer, gyroscope, magnetometer, inertial measurement unit, or combinations thereof. The motion sensor 210 detects movement of the user, including linear acceleration, angular velocity, orientation, rotation, cadence, impact, body angle, direction, speed, and movement timing. Data from the motion sensor 210 may be used to determine whether the user is performing a movement correctly, whether the user is synchronized with other users, or whether the user has deviated from a reference movement template.

The wearable device further includes a microcontroller or processor 220. The microcontroller 220 may receive data from the motion sensor 210, RFID reader 230, wireless communication module 240, and other components of the device. The microcontroller 220 may execute instructions for filtering sensor data, detecting motion events, identifying deviations, controlling haptic feedback, managing wireless communication, and conserving battery power. In some implementations, the microcontroller 220 performs real-time processing locally on the wearable device. In other implementations, the microcontroller 220 transmits sensor data to a remote computing device, such as a smartphone, tablet, server, or cloud platform, for further analysis.

FIG. 2 also shows an RFID reader 230. The RFID reader 230 may detect RFID tags, markers, or beacons positioned in the training environment, on props, on equipment, on boundaries, or on other users. The RFID reader 230 may be used to determine whether the user is near a designated location, whether the user is within a proper formation position, whether the user has approached a boundary, or whether the user is near another performer or object. Although an RFID reader is shown, other proximity or location technologies may be used, including Bluetooth ranging, ultra-wideband positioning, NFC, optical markers, GPS, or other spatial awareness systems.

The wearable device further includes a wireless communication module 240. The wireless communication module 240 may communicate using Bluetooth, Wi-Fi, ultra-wideband, NFC, cellular, mesh networking, or other wireless communication protocols. The wireless communication module 240 allows the wearable device to transmit movement data to a coach application, mobile device, tablet, cloud server, or other computing system. The wireless communication module 240 may also receive instructions, updated choreography, movement templates, synchronization thresholds, haptic commands, firmware updates, or coach-generated feedback.

The wearable device includes one or more haptic feedback modules, including a top haptic feedback module 250 and a bottom haptic feedback module 260. These haptic feedback modules may include vibration motors or other tactile actuators. By placing haptic feedback modules at different locations within the device, the system can provide directional feedback to the user. For example, activation of the top haptic feedback module 250 may instruct the user to move upward, forward, or increase amplitude, while activation of the bottom haptic feedback module 260 may instruct the user to move downward, backward, or reduce amplitude. Additional actuators may be positioned on left and right sides of the device to provide lateral cues.

FIG. 2 further shows a battery 270. The battery 270 supplies electrical power to the motion sensor 210, microcontroller 220, RFID reader 230, wireless communication module 240, haptic feedback modules 250 and 260, status LEDs 290, and other electronic components. The battery 270 may be rechargeable and may support wired or wireless charging. Suitable batteries may include lithium-ion batteries, lithium-polymer batteries, solid-state batteries, or other portable power sources. The battery capacity may be selected based on the intended use, including short training sessions, full-day use, competitions, rehabilitation monitoring, or extended remote coaching.

A power management circuit 280 is also shown in FIG. 2. The power management circuit 280 may regulate voltage, manage charging, monitor battery status, control power distribution, and place selected components into low-power or sleep modes when not in use. The power management circuit 280 may help extend battery life and ensure stable operation of the wearable device. In some implementations, the power management circuit 280 may communicate battery level information to the microcontroller 220, which may then display the battery level using the status LEDs 290 or transmit the battery status to the coach application.

FIG. 2 further includes status LEDs 290. The status LEDs 290 may correspond to the status LEDs 120 shown externally in FIG. 1. The status LEDs 290 may be controlled by the microcontroller 220 and may provide visual indications of power, pairing status, data transmission, battery level, training status, or feedback state. In some implementations, the LEDs may be positioned beneath a translucent portion of the housing so that they are visible to the user or coach during use.

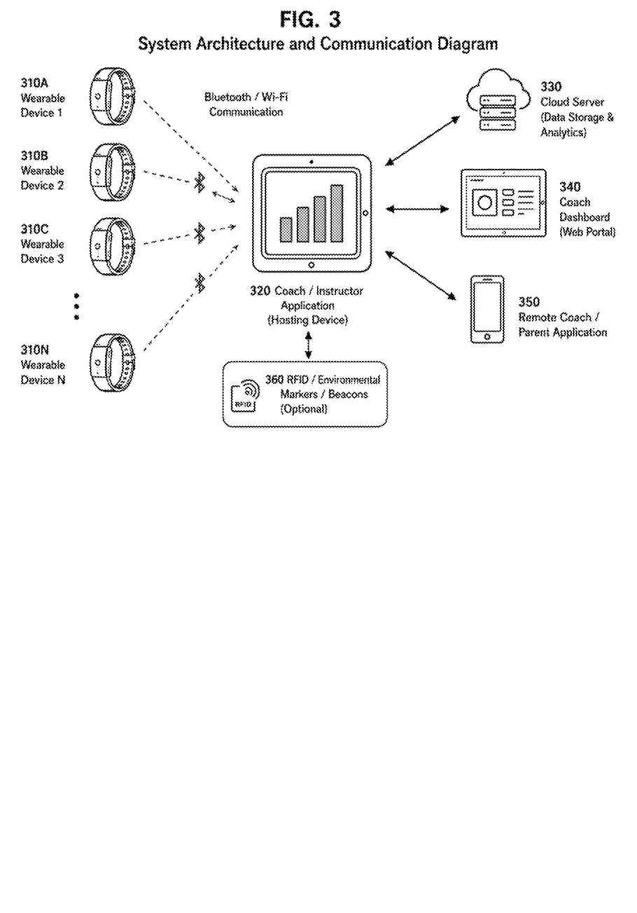

FIG. 3 depicts an exemplary system architecture and communication diagram. The system includes a plurality of wearable devices 310A, 310B, 310C, through 310N. Each wearable device may be worn by a different user, or multiple wearable devices may be worn by the same user at different body locations. For example, a dance team, cheer squad, sports team, rehabilitation group, military drill group, or therapy class may each include multiple participants wearing respective wearable devices. The notation “310N” indicates that any suitable number of wearable devices may be used, and the system is not limited to three devices.

Each wearable device 310A-310N may collect movement data and wirelessly transmit the data to a coach or instructor application 320. The wireless communication may include Bluetooth, Wi-Fi, ultra-wideband, mesh networking, or other wireless protocols. The dashed lines shown between the wearable devices and the coach/instructor application 320 represent wireless data transmission. Such data may include raw sensor data, processed movement metrics, synchronization information, battery status, device identification, user identification, location information, and detected movement deviations.

The coach or instructor application 320 may operate on a tablet, smartphone, laptop, desktop computer, or other computing device. The application 320 may receive movement data from multiple wearable devices and analyze the data in real time. The application may display synchronization metrics, timing information, movement errors, formation maps, individual user performance, group performance, and corrective feedback options. The application 320 may also transmit instructions back to the wearable devices, including haptic feedback commands, updated movement templates, or synchronization cues.

FIG. 3 further shows a cloud server 330. The cloud server 330 may store movement data, user profiles, training histories, choreography templates, analytics, synchronization scores, and performance trends. The cloud server 330 may also perform more complex data processing, machine learning analysis, predictive movement modeling, remote coaching coordination, and long-term performance tracking. Communication between the coach/instructor application 320 and the cloud server 330 may be bidirectional, allowing data to be uploaded for storage and analytics and allowing updated information to be downloaded to the local application.

FIG. 3 also shows a coach dashboard or web portal 340. The coach dashboard 340 may allow a coach, instructor, trainer, therapist, or administrator to review performance information from a larger screen or remote computer. The dashboard 340 may display team-level analytics, individual user reports, synchronization rankings, formation performance, deviation histories, battery status, and training session summaries. The dashboard 340 may also allow a coach to create or modify movement templates, assign drills, review past sessions, and configure feedback thresholds.

A remote coach or parent application 350 is also shown in FIG. 3. The remote application 350 may be used by a remote coach, parent, therapist, evaluator, or other authorized user. The remote application may receive live or stored performance data from the coach/instructor application 320 or cloud server 330. This allows remote monitoring, remote instruction, parental review, tele-rehabilitation, or distributed coaching. For example, a remote instructor may observe whether a user is performing a rehabilitation exercise correctly, or a parent may review training progress for a child athlete or dancer.

FIG. 3 further includes RFID or environmental markers/beacons 360. The markers or beacons 360 may be placed at fixed or movable locations within the training environment. The wearable devices 310A-310N or the coach/instructor application 320 may use the markers 360 to determine position, proximity, formation alignment, zone entry, boundary crossing, or relationship to equipment or props. The markers 360 may include RFID tags, Bluetooth beacons, ultra-wideband anchors, NFC tags, optical markers, or other location references. These markers may help the system determine whether participants are properly spaced, whether a formation is correct, or whether a user has entered or exited a designated zone.

The arrows in FIG. 3 illustrate that the system may support bidirectional communication between components. For example, wearable devices may transmit movement data to the coach/instructor application 320, and the coach/instructor application 320 may transmit corrective cues back to the wearable devices. The coach/instructor application 320 may communicate with the cloud server 330 for storage and analytics, with the coach dashboard 340 for expanded visualization, and with the remote coach or parent application 350 for remote monitoring. The system therefore provides both local real-time feedback and remote or cloud-based analysis.

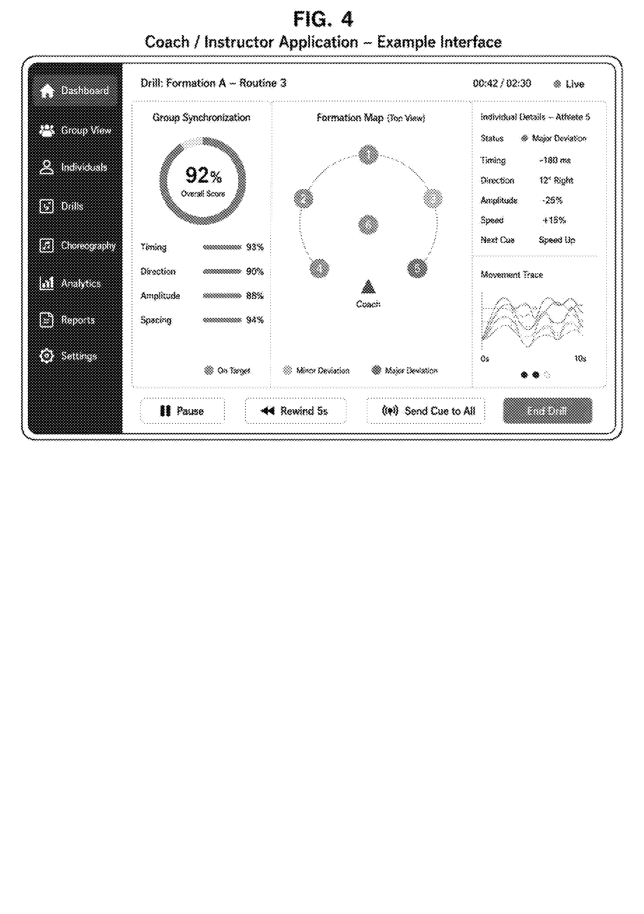

FIG. 4 depicts an exemplary coach or instructor application interface configured to display synchronization analytics, movement quality information, formation positioning, and corrective guidance information in real time. The illustrated interface may be displayed on a tablet, laptop, desktop computer, smartphone, smart display, or other computing device used by a coach, instructor, therapist, trainer, evaluator, or administrator. The interface provides a centralized platform for monitoring one or more users wearing the wearable synchronization devices described herein. Although a particular screen layout is illustrated, the arrangement, formatting, colors, visualizations, and displayed metrics may vary depending on the intended application, user preferences, sport, training environment, or software implementation.

FIG. 4 includes a navigation panel positioned along the left side of the interface. The navigation panel may provide access to dashboard views, group synchronization views, individual athlete views, choreography libraries, drill libraries, analytics pages, reports, settings, historical recordings, or remote coaching tools. The navigation panel allows a coach or instructor to quickly switch between different operational modes and monitoring environments. In some implementations, the navigation panel may also provide access to team management functions, user assignments, movement template editing, synchronization threshold settings, or notification controls.

The upper portion of FIG. 4 displays a drill or training session identifier, shown as “Formation A – Routine 3.” This identifier may represent a choreography routine, sports drill, rehabilitation exercise, military formation, gymnastics sequence, or other predefined movement activity. The upper portion of the interface may additionally display elapsed time, remaining time, synchronization status, recording status, wireless connection status, or live monitoring indicators. The illustrated “Live” indicator represents that the wearable devices are actively transmitting movement data to the coach application in real time.

FIG. 4 further includes a group synchronization panel. The group synchronization panel may display an overall synchronization score representing the timing and movement consistency of the group relative to one or more reference movements or reference performers. In the illustrated example, the synchronization score is displayed as a circular percentage indicator, although other visualizations may be used, including gauges, graphs, numerical values, color-coded indicators, heat maps, or trend lines. The synchronization panel may additionally display sub-scores for timing, directional alignment, movement amplitude, spacing consistency, cadence consistency, posture, formation integrity, or other performance characteristics.

FIG. 4 also depicts a formation map or top-view positioning map. The formation map may display the relative locations of multiple users wearing wearable synchronization devices. Each numbered circle shown within the formation map may correspond to an individual performer, athlete, participant, patient, or trainee. The formation map may allow the coach or instructor to determine whether the users are correctly positioned relative to one another or relative to predefined target locations. The positioning information may be derived from RFID systems, ultra-wideband positioning systems, Bluetooth ranging systems, GPS systems, optical systems, or other spatial awareness technologies. In some implementations, users who are correctly aligned may be displayed in one color, while users who are deviating from target positioning may be displayed in other colors according to deviation severity.

The right side of FIG. 4 depicts an individual participant detail panel. The participant detail panel may display information associated with a selected user or wearable device. Such information may include movement deviation magnitude, timing deviation, directional error, amplitude error, speed deviation, synchronization status, movement history, fatigue indicators, or biometric information. In the illustrated example, the interface identifies that the selected participant is exhibiting a timing deviation, directional deviation, and amplitude deviation. The interface may additionally recommend corrective actions, such as speeding up, slowing down, increasing movement range, repositioning, or adjusting cadence.

FIG. 4 further includes a movement trace graph or movement waveform visualization. The movement trace graph may display movement trajectories, timing traces, acceleration curves, angular velocity curves, synchronization patterns, or other motion-related analytics over time. Multiple lines may represent different users, different body regions, different movement axes, or comparisons between the user and the reference movement. The movement trace graph allows the coach or instructor to visually evaluate synchronization quality, consistency, rhythm, smoothness, or movement variability.

The lower portion of FIG. 4 includes various operational controls. Such controls may include pause controls, replay controls, rewind controls, session recording controls, synchronization reset controls, and feedback transmission controls. The illustrated “Send Cue to All” control may allow the coach or instructor to simultaneously transmit corrective haptic, visual, or auditory cues to multiple wearable devices. The interface may also include controls for modifying synchronization thresholds, adjusting feedback intensity, selecting choreography routines, assigning participant roles, or generating reports.

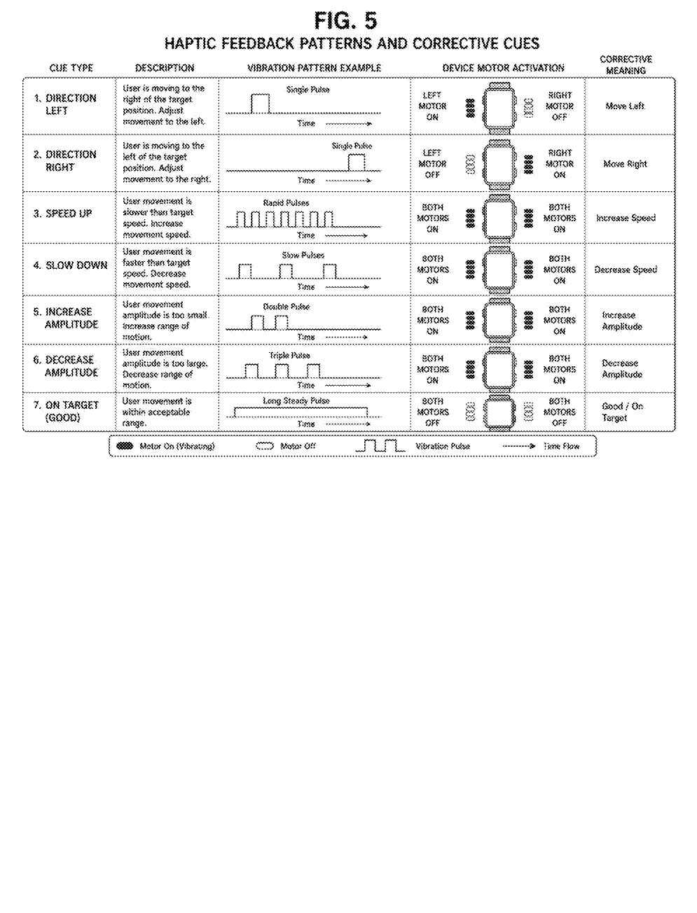

FIG. 5 depicts exemplary haptic feedback patterns and corrective cues generated by the wearable synchronization system. The figure illustrates how different vibration patterns, pulse sequences, motor activations, and tactile outputs may correspond to different corrective instructions communicated to the user. The illustrated table format is merely exemplary and is intended to conceptually demonstrate how the haptic system may communicate movement corrections in a simple and intuitive manner during real-time performance or training.

In FIG. 5, the first illustrated cue corresponds to a “Move Left” instruction. In this example, a vibration motor positioned on the left side of the wearable device is activated to indicate that the user should shift position or movement direction toward the left. The vibration pattern may comprise a single pulse, repeated pulse, directional vibration, increasing intensity vibration, or other tactile signal. The system may determine that the user is positioned too far to the right relative to a target location, reference movement, formation position, or another user, and therefore generates a corrective leftward cue.

FIG. 5 further illustrates a “Move Right” cue generated through activation of a right-side vibration motor. The “Move Right” cue may indicate that the user has deviated too far toward the left and should reposition toward the right. Similar directional cues may be provided for forward movement, backward movement, upward positioning, downward positioning, rotational correction, posture adjustment, or body orientation changes. Different body-worn devices may provide different directional meanings depending on placement location, user role, or activity type.

Additional cues shown in FIG. 5 include “Speed Up” and “Slow Down” cues. These cues may be generated when the user’s movement cadence deviates from the expected timing associated with a choreography sequence, sports drill, rehabilitation exercise, musical beat, or synchronized group movement. Rapid pulse sequences may indicate that the user should increase movement speed or cadence, while slower pulse sequences may indicate that the user should reduce speed or delay movement timing. The pulse frequency, pulse spacing, vibration intensity, and pulse duration may all be modified to convey different urgency levels or correction magnitudes.

FIG. 5 additionally illustrates “Increase Amplitude” and “Decrease Amplitude” corrective cues. Such cues may indicate that the user’s movements are either too small or too exaggerated relative to a reference movement. For example, the system may determine that a dancer’s arm extension is insufficient, that an athlete’s stride length is too short, or that a rehabilitation exercise is not reaching a prescribed range of motion. Conversely, the system may determine that the user is overextending or applying excessive movement force. The wearable device may then provide corresponding tactile instructions to increase or decrease movement amplitude.

FIG. 5 also illustrates an “On Target” or “Correct Performance” cue. In some implementations, the absence of vibration may indicate that the user is performing correctly and remains within acceptable synchronization thresholds. In other implementations, a unique confirmation pulse, sustained vibration pattern, or gentle rhythmic cue may indicate successful synchronization or proper positioning. Positive feedback cues may encourage users to maintain correct movement patterns and may reinforce training consistency.

The lower portion of FIG. 5 includes a legend illustrating exemplary vibration states, motor activation states, and pulse diagrams. The legend demonstrates that different combinations of motor activations, pulse timings, pulse shapes, vibration durations, and vibration frequencies may be used to communicate different instructions. Although the illustrated examples show left and right motor activations, additional motors may be positioned at upper, lower, front, rear, diagonal, or body-specific locations to provide more complex corrective guidance. The haptic patterns shown in FIG. 5 are exemplary only, and numerous alternative tactile languages and feedback schemes are contemplated.

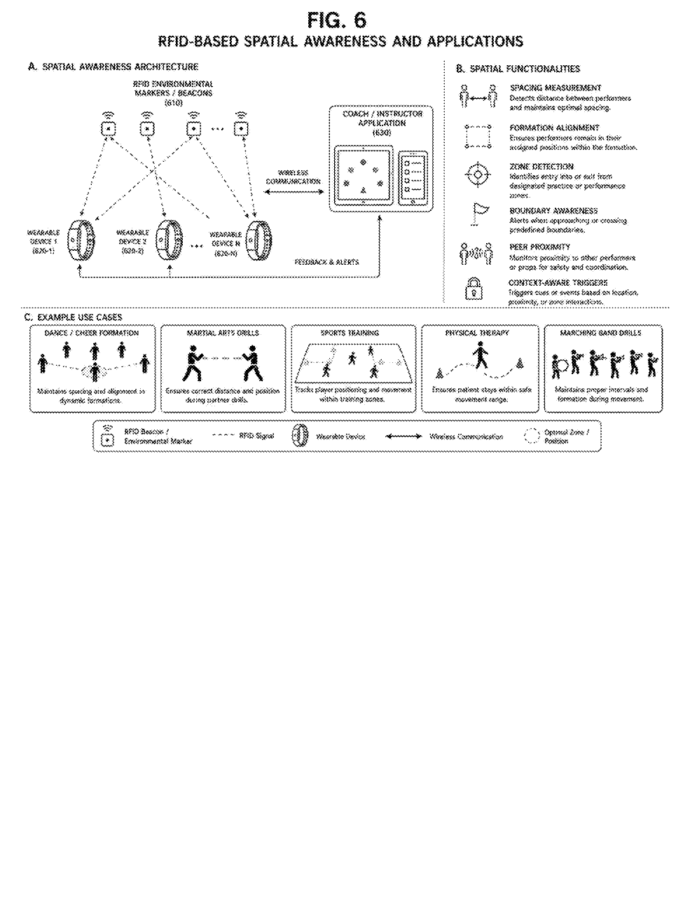

FIG. 6 depicts an exemplary RFID-based spatial awareness system and related applications. The figure illustrates how RFID markers, environmental beacons, wearable devices, and software systems may cooperate to determine positioning, spacing, formation alignment, zone awareness, and contextual movement information. Although RFID systems are specifically illustrated, the disclosed concepts may similarly be implemented using Bluetooth beacons, ultra-wideband anchors, NFC systems, optical markers, GPS systems, lidar systems, or other location-aware technologies.

The left side of FIG. 6 illustrates an exemplary spatial awareness architecture. Multiple RFID environmental markers or beacons 610 are positioned throughout a training or performance environment. These markers may define target locations, formation positions, movement boundaries, restricted areas, obstacle zones, pathways, or other spatial references. The wearable devices 620-1 through 620-N may detect signals from the environmental markers and determine their relative position within the environment. The wearable devices may communicate positioning information to the coach or instructor application 630 through wireless communication links.

The coach or instructor application 630 shown in FIG. 6 may display participant positioning information, formation alignment, zone occupancy, movement pathways, or proximity relationships between users. The application may determine whether users remain properly spaced, whether participants have deviated from assigned positions, or whether formation integrity has been compromised. In some implementations, the coach application may generate corrective feedback instructions responsive to detected spatial deviations and transmit those instructions back to the wearable devices.

The right side of FIG. 6 illustrates several exemplary spatial functionalities supported by the system. One functionality includes spacing measurement between participants. The system may continuously monitor the distance between users and determine whether the spacing falls within acceptable thresholds. Another functionality includes formation alignment monitoring, where the system determines whether users remain correctly positioned relative to a predefined geometric arrangement. Additional functionalities may include zone detection, boundary awareness, peer proximity monitoring, obstacle awareness, and context-aware triggers.

Boundary awareness functionality may allow the system to determine whether a user is approaching or crossing predefined boundaries. For example, a sports player may be alerted when moving outside a designated drill zone, or a rehabilitation patient may receive feedback when exceeding a safe movement range. Peer proximity monitoring may determine whether performers are too close together or too far apart, thereby reducing collision risks and improving coordinated spacing. Context-aware triggers may allow the system to generate cues or initiate events when a user enters a particular location or reaches a specific spatial relationship relative to another participant or environmental marker.

The lower portion of FIG. 6 depicts several exemplary use-case environments for the RFID-based spatial awareness system. The illustrated dance or cheer formation example demonstrates how the system may maintain proper spacing and alignment among performers during choreography. The martial arts example demonstrates how the system may determine appropriate spacing and positioning between training partners. The sports training example illustrates player positioning and movement tracking within a training zone. The physical therapy example illustrates movement monitoring within a prescribed rehabilitation range, while the marching band example demonstrates maintenance of formation integrity and spacing during coordinated movement.

The legend shown in FIG. 6 illustrates exemplary representations for RFID beacons, wearable devices, wireless communication links, and optimal positioning zones. The dashed communication lines shown throughout the figure represent wireless communication pathways between the wearable devices, environmental markers, and coach application. The illustrated architecture demonstrates how the wearable synchronization system may integrate motion sensing, spatial awareness, environmental positioning, and corrective feedback into a unified movement coordination platform.

The present discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of items used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification or claims refer to at least one of something selected from the group consisting of A, B, C … and N, the text should be interpreted as requiring only one element from the group, not A plus N, or B plus N, etc.

What is claimed is:

1. A wearable movement synchronization system comprising:
at least one wearable device configured to be worn by a user;
wherein the wearable device comprises at least one motion sensing system configured to detect movement of the user, and a wireless communication system configured to transmit movement data; and
a feedback system configured to provide corrective feedback responsive to a detected movement deviation.

2. The system of claim 1, wherein the motion sensing system comprises an accelerometer.

3. The system of claim 1, wherein the motion sensing system comprises a gyroscope.

4. The system of claim 1, wherein the motion sensing system comprises an inertial measurement unit.

5. The system of claim 1, wherein the feedback system comprises a haptic feedback system.

6. The system of claim 5, wherein the haptic feedback system comprises a plurality of vibration motors configured to provide directional feedback.

7. The system of claim 1, wherein the wearable device further comprises an RFID reader.

8. The system of claim 7, wherein the RFID reader determines proximity to an environmental marker.

9. The system of claim 1, wherein the system compares the movement data to a predefined movement template.

10. The system of claim 1, wherein the system identifies synchronization deviations between multiple users.

11. The system of claim 1, wherein the corrective feedback is delivered within one second of detecting the movement deviation.

12. The system of claim 1, wherein the wearable device is configured to communicate with a remote software platform.

13. The system of claim 1, wherein the system generates a synchronization score.

14. The system of claim 1, wherein the system comprises machine learning functionality configured to predict movement deviations.

15. A method for improving synchronized movement, comprising:
collecting movement data from one or more wearable devices;
comparing the movement data to one or more reference movements;
detecting one or more movement deviations; and
providing corrective feedback responsive to the one or more movement deviations.

16. The method of claim 15, wherein the corrective feedback comprises directional haptic feedback.

17. The method of claim 15, wherein the movement deviations comprise timing deviations.

18. The method of claim 15, wherein the movement deviations comprise spacing deviations between multiple users.

19. The method of claim 15, wherein the movement data is analyzed using a machine learning model.

20. A non-transitory computer-readable medium storing instructions that, when executed by one or more processors, cause a system to:
receive movement data from a plurality of wearable devices;
determine synchronization quality among a plurality of users;
identify one or more movement deviations; and
generate corrective feedback configured to improve synchronization among the plurality of users.
